(19) United States
(12) Patent Application Publication
(10) Pub. No.: US 2002/0062228 A1
(43) Pub. Date: May 23, 2002

(54) INTERACTIVE COMPUTER SYSTEM FOR OBTAINING INFORMED CONSENT FROM A PATIENT

(76) Inventors: HAROLD D. PORTNOY, WEST BLOOMFIELD, MI (US); MICHAEL G. STYS, WEST BLOOMFIELD, MI (US)

Correspondence Address: ROBERT P RENKE, LYON & ARTZ, SUITE 250, 28333 TELEGRAPH, SOUTHFIELD, MI, 48034

(21) Appl. No.: 09/461,883

(22) Filed: Dec. 15, 1999

Related U.S. Application Data
(63) Continuation-in-part of application No. 09/020,002, filed on Feb. 6, 1998, now abandoned.

(51) Int. Cl. G06F 17/60

(52) U.S. Cl. 705/3

(57) ABSTRACT

An automated informed consent system uses a computer to inform a patient about a proposed medical procedure and to verify that the patient understands the material presented. The system provides an audiovisual presentation using animation and/or voice-over to aid in the patient's understanding of the procedure and associated risks. The system comprises a patient interface connected to a network wherein the patient interface includes at least one input device for use by the patient to provide input to the interface and a screen for displaying information to the patient. A server connected to the network in operative communication with the patient interface is also included. The server comprises a program stored in memory and accessible by the patient interface. Once a connection between the patient interface and server has been established, the interface is operable under control of the program to present information concerning a medical procedure to the patient via the screen. The patient interface also requests input from the patient via the input device, and determines from the input whether the patient has achieved a predetermined level of understanding of the information presented. The interface is further operable under the control of the program to generate a consent form for the medical procedure for review by a physician and execution by the patient.

### TECHNICAL FIELD

This invention relates in general to interactive computer systems used for medical purposes and, more particularly, to the use of such computer systems by patients as an adjunct to treatment.

### BACKGROUND OF THE INVENTION

It is almost universal practice for a physician to obtain consent from a patient prior to performing any medical procedure on the patient. For all procedures, the physician typically seeks to obtain informed consent from the patient; that is, the physician seeks to obtain the consent of the patient after the patient has become properly informed not only about the procedure and its expected benefits, but also about the attendant risks and possible complications. The most basic form of informed consent involves the physician discussing the procedure with the patient. In this way, the patient is best able to make an informed judgment as to whether the patient wishes to undergo the procedure.

One problem inherent in this technique of obtaining informed consent is that it does not provide any reliable indication of whether the patient truly understands the physician's discussion. The patient may not understand the terminology, making it difficult for the patient to make an informed decision about the procedure. Sometimes, the discussion with the patient may be supplemented by the use of models, illustrations, booklets and teaching movies, tapes, or videos. While perhaps aiding in the patient's understanding of the procedure and attendant risks, these learning aids still do not provide any reliable indication that the patient properly comprehends the procedure and its risks.

U.S. Pat. No. 5,495,305, issued Feb. 27, 1996, to N. F. Martin et al., seeks to improve the informed consent process in the case of ophthalmic surgery using a contact lens or similar device that simulates the possible visual distortion that could result from the surgery. In the primary embodiment disclosed, the device comprises contact lenses that provide the appropriate visual distortion. In another disclosed embodiment, the device can be virtual reality goggles that are used to simulate the distortion. The goggles include a camera, display, and suitable software for providing the appropriate distortion to the images received by the camera. The device permits the patient to experience the potential visual problems resulting from surgery rather than having to rely upon a verbal description by the doctor. While perhaps suitable for its intended purpose, the device disclosed by Martin et al., has only limited applicability, such as eye surgery, where the patient can experience the potential risks of a procedure in a manner that is not harmful to the patient. Also, the device disclosed by Martin et al., only educates the patient about the risks associated with the procedure, not about the expected benefits of the procedure nor even about the procedure itself.

Apart from not understanding the information provided by the physician, patients sometimes simply forget what they were told about the procedure. Several studies have shown that approximately thirty percent of patients cannot remember that they were informed about the procedure they underwent. As a result, when a procedure does not produce the expected results, the patient may bring legal proceedings against the physician for malpractice claiming that he or she was not informed or was inadequately informed of the risks associated with the procedure. To protect themselves from these situations, some physicians have resorted to taping their conversations with their patients as a way of recording the fact that the patient was adequately informed. While this helps protect the physician in the event of litigation, it does nothing to help insure the patient understands the information provided by the physician. Moreover, taping one's conversation with a patient is a somewhat adversarial approach that can be detrimental to the patient-physician relationship.

The most widespread technique for evidencing the fact that a patient has given informed consent is by way of a consent form signed by the patient. These forms typically include a statement of the risks and possible complications associated with the procedure and may even include a basic description of the procedure and the need for post-operative care. These forms are useful for both the patient and the physician. For the patient, being required to sign the form before the procedure helps indicate the gravity of the patient's decision to consent to the procedure. For the physician, the consent form provides evidence that the patient was informed about the procedure and actually consented to the procedure.

While useful for evidentiary purposes, the consent form does not provide a reliable indication that the patient truly understood the procedure and attendant risks. Rather, in some instances, the patient signs the form without adequately understanding the procedure and its risks. In other instances, the patient may be presented with and may sign the consent form before being given any real information about the procedure. Accordingly, there exists the need for a system for obtaining informed consent that not only provides evidence that the patient consented to a procedure, but that also indicates that the consent was obtained after the patient was informed about the procedure and was obtained as a result of an informed decision by the patient.

### SUMMARY OF THE INVENTION

The present invention is directed to an automated informed consent system that overcomes the above-noted shortcomings of currently used techniques for obtaining informed consent. The system includes a computer having at least one input device for use by the patient to provide input to the computer and a screen for displaying information to the patient. The system also includes a computer program stored in non-volatile memory, such as on a CD-ROM, DVD, or the computer's hard drive. The computer is operable under control of the program to present information concerning a medical procedure to the patient via the screen, to request input from the patient via the input device, and to determine from the input whether the patient has achieved a predetermined level of understanding of the information presented. The computer is further operable under control of the program to provide the patient with repeated and/or additional information concerning the medical procedure until the patient demonstrates that he or she has achieved the predetermined level of understanding. The system also provides a consent form for the medical procedure, which can then be executed by the patient to acknowledge that the patient consents to the medical procedure.

The invention improves the process of obtaining informed consent since completion of the presentation only occurs after the patient has demonstrated that he or she sufficiently understands the information presented. This is advantageous not only because it helps insure that the patient understands the risks and makes an informed decision, but also because the fact that the patient completed the presentation may be useful later in litigation to prove that the patient's consent was informed.

In accordance with one aspect of the invention, the computer provides the consent form only after the patient has demonstrated to the system that he or she has achieved the necessary, predetermined level of understanding of the information presented. This can be accomplished using a printer attached to the computer, in which case the consent form can be automatically printed after successful completion of the presentation. This is advantageous because it prevents the patient from signing the consent form until after he or she is adequately informed, a fact that may be useful later in litigation to prove that the patient consented only after being adequately informed about the procedure and attendant risks.

In accordance with another aspect of the invention, the information is presented as a number of modules, with each module including a presentation of information followed by testing of the patient on the information presented during that module. The computer can present the modules sequentially and can require that the patient demonstrate a certain level of comprehension of the information presented during one module before beginning another module.

Preferably, the system includes at least one speaker connected to the computer which presents information to the patient as an audiovisual presentation using the screen and speaker. Also, the visual presentation preferably includes animated motion to help aid in the patient's understanding of the material presented.

In one aspect of the invention, a network system for use by a patient to provide informed consent to a medical procedure is provided. The system comprises a patient interface connected to a network wherein the patient interface includes at least one input device for use by the patient to provide input to the interface and a screen for displaying information to the patient. A server connected to the network in operative communication with the patient interface is also included. The server comprises a program stored in memory and accessible by the patient interface. Once a connection between the patient interface and server has been established, the interface is operable under control of the program to present information concerning a medical procedure to the patient via the screen. The patient interface also requests input from the patient via the input device, and determines from the input whether the patient has achieved a predetermined level of understanding of the information presented. The interface is further operable under the control of the program to generate a consent form for the medical procedure for review by a physician and execution by the patient.

### BRIEF DESCRIPTION OF THE DRAWINGS

A preferred exemplary embodiment of the present invention will hereinafter be described in conjunction with the appended drawings, wherein like designations denote like elements, and:

FIG. 1 is a block diagram of a preferred embodiment of an automated informed consent system of the present invention;

FIG. 2 is a flow chart that provides an overview of the software process utilized by the automated informed consent system of FIG. 1;

FIG. 3 is a flow chart of Module 1 of the process depicted in FIG. 2;

FIG. 4 is a flow chart of Module 2 of the process depicted in FIG. 2;

FIG. 5 is a flow chart of Module 3 of the process depicted in FIG. 2;

FIG. 6 is a flow chart of Module 4 of the process depicted in FIG. 2;

FIG. 7 is a block diagram of a network-based implementation of an informed consent certification procedure according to the present invention;

FIG. 8 is a block diagram showing one embodiment of the central controller of FIG. 7;

FIG. 9 is a block diagram showing one embodiment of the doctor/patient interface of FIG. 7;

FIG. 10 is a logic flow diagram of a network-based implementation of an informed consent certification procedure according to the present invention;

FIG. 11 is a detailed diagram of a portion of the network-based implementation of FIG. 10;

FIG. 12 is a detailed diagram of another portion of the network-based implementation of FIG. 10; and

FIG. 13 is a detailed diagram of another portion of the network-based implementation of FIG. 10.

### DETAILED DESCRIPTION OF THE PREFERRED EMBODIMENTS

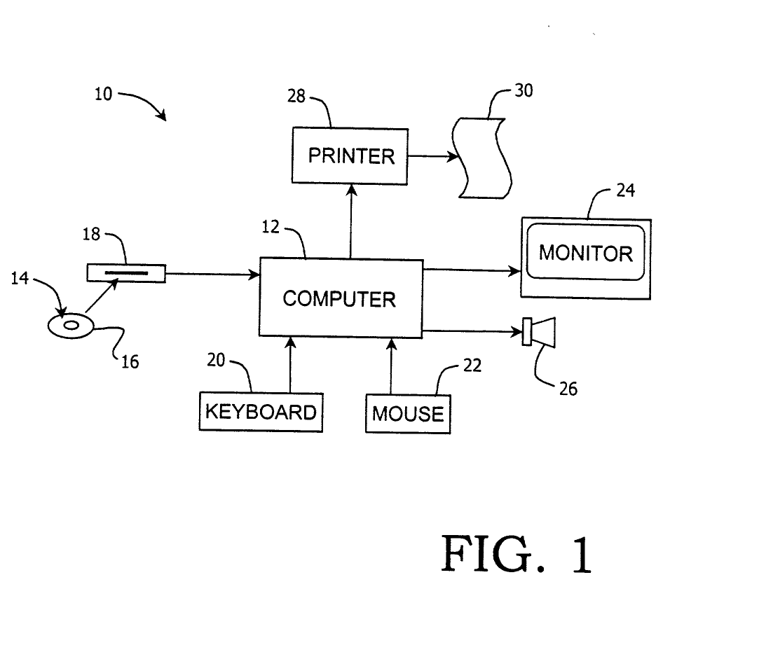

Referring to FIG. 1, there is shown an automated informed consent system of the present invention, designated generally as 10. As shown, informed consent system 10 can be implemented using a general purpose computer 12 that is specially programmed by a computer program 14 stored on a CD-ROM or other non-volatile storage memory 16. Computer 12 includes a CD-ROM drive 18 that it uses to access program 14 from CD-ROM 16. Computer 12 further includes two other input devices; namely, a keyboard 20 for use by the patient to input text and a mouse or other serial input device 22 that is used by the patient in conjunction with the graphical user interface provided by program 14. Computer 12 also has a number of output devices, including a computer screen or monitor 24, one or more speakers 26, and a printer 28 that is used to print out a consent form 30 at the conclusion of the presentation provided by program 14.

In general, program 14 uses monitor 24 and speaker 26 to provide the patient with an audiovisual presentation of information regarding the proposed medical procedure. The presentation is separated into a number of informational modules, each of which is followed by a number of questions, all of which must be answered correctly before the patient can begin the succeeding module. Any incorrect answer by the patient results in the module being repeated. Each module is directed to a different aspect of the procedure and must be completed to insure that the patient understands all of the relevant aspects of the procedure. Once the patient has successfully completed all modules, consent form 30 is printed by printer 28 and is given to the patient to sign if he or she consents to undergoing the procedure.

Advantageously, all of the components of FIG. 1 except program 14 on CD-ROM 16 can be conventional components connected together in a conventional manner. For example, computer 12 can be a standard personal computer, such as a Pentium-based computer running Windows95. The physician can, therefore, either use an existing computer or can simply purchase any one of a number of widely available compatible computers and then need only obtain a copy of program 14. Program 14 can be distributed as shrink-wrapped software, either through retail or by mail order, or can be downloaded electronically over a global network such as the Internet, or run directly from the Internet.

As an alternative to CD-ROM 16, the non-volatile storage memory can comprise other types of optical disks, such as DVD, or can comprise other types of non-volatile storage memory 16 along with program 14 stored thereon together comprise a digital storage device that can be used by computer 12 to provide the automated informed consent system 10 of the present invention.

As will be appreciated by those skilled in the art, program 14 may include a number of individually executable files, libraries, audio files, video files, and other program components, all of which may be stored as individual files. It will, therefore, be understood that, as used herein, the term “program” is meant to include the executable file(s) and any libraries or other support files necessary to configure computer 12 into informed consent system 10.

Prior to its first use by a patient, program 14 is initially installed on computer 12 by the physician or an office staff member. Preferably, program 14 includes an installation program that registers the program with the computer's operating system, provides one or more shortcuts to the executable program, and, if desired, permits some or all of program 14 to be loaded from CD-ROM 16 onto the computer's hard drive for faster performance.

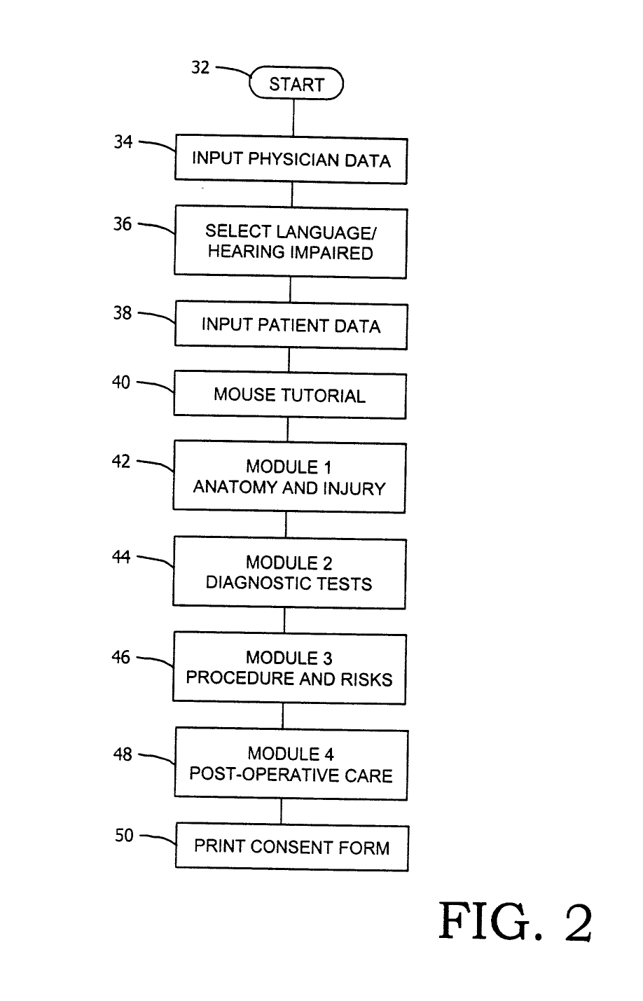

FIG. 2 provides an overview of the process flow of program 14 when computer 12 is used by the patient to learn about and consent to a particular medical procedure. The program is begun at start block 32 by, for example, double-clicking on a shortcut or icon displayed on monitor 24. The first step in the process is to input physician data into the program, as indicated at block 34. This data is input using keyboard 20 and includes such information as the physician's name, address, and organization. The inputting of physician data can be handled in any of a number of different ways. It can be done by an office staff member or the patient each time the program is run. Alternatively, it can be entered as a part of the original installation of the program by the physician or office staff, in which case the information may not need to be re-entered each time the program is used. If the program is used by more than one physician, then the program can be designed to accept information for each of a number of physicians at the initial installation and the, when being set up for use by a particular patient, the patient's physician can be selected from those who have previously been entered into the program. Other such variations will become apparent to those skilled in the art.

Once the physician data has been entered or selected, the next step is to select the desired language of instruction (e.g., English or Spanish in the illustrated embodiment). This is shown at block 36. This selection can be done by an office staff member for the patient or can be left to the patient. Preferably, the program also accommodates the hearing impaired by allowing the patient to select an option which causes the program to provide a full textual display of all information presented.

Once the language has been selected, the process moves to block 38 where patient data is input via keyboard 20. This data can include the patient's name, address, hospital, identifier number, birthdate, insurance carrier, and other such relevant information. As with the other data inputted into the computer, this can be done for the patient or carried out by the patient himself. As will be appreciated, rather than manually entering the physician and patient data, the program can be designed to interface with other database or recordkeeping software. In this way, the user need only identify the patient and physician and the program can then retrieve the desired information automatically from the appropriated database.

The patient data input can also include an identification of the medical procedure, whether by typing in the name of the procedure or by selecting it from among a displayed list of procedures. If desired, program 14 can be directed to a single type of procedure, e.g., lumbar disk surgery, or can include a number of different presentations, each of which is directed to a different medical procedure. By simply selecting the desired procedure, program 14 causes the associated presentation to be run. Moreover, by including each presentation as a separate computer file or group of files, a single executable program can be used to access and initiate any of an unlimited number of presentations. In this way, once the basic program shell has been developed along with one or more presentations, additional presentations can be independently developed and easily added later with little or no modification of the main program.

Once the patient data has been input, the process moves to block 40 where a short tutorial is presented to teach the patient how to manipulate and use the mouse 22. This tutorial can be made optional for patients familiar with the basic operation of a personal computer.

The presentation then begins at block 42, which is the first of a number of informational modules that together comprise the complete presentation. By presenting the information to the patient in the form of modules, the presentation can be broken down and organized into groups of information related to the medical procedure and the patient can be tested on each group. This organization of the information for the patient helps aid the patient's comprehension of the material. The number and content of the modules may vary depending upon the medical procedure involved. For lumbar disk surgery, four modules can be used, as indicated by blocks 42, 44, 46, and 48 in the illustrated embodiment. Module 1 is directed to a description of the injury or problem and the anatomy related to the problem. Module 2 explains the diagnostic tests that might have been used to arrive at the diagnosis. Module 3 describes the medical procedure, risks, and possible complications. Module 4 is directed to post-operative care and long term therapy. Once all modules have been completed, the process moves to block 50 where consent form 30 is printed for execution by the patient.

As will be discussed in greater detail below, the patient must demonstrate that he or she has achieved a sufficient level of understanding of the information presented before the program will cause printer 28 to print out consent form 30. This can be accomplished by testing the patient at the conclusion of each module and requiring that the patient demonstrate a sufficient level of comprehension of the information presented during each module before the patient can begin a succeeding module. The required level of understanding is predetermined as a part of the design of program 14 and can be chosen based upon the relevant Standards of Care for the particular procedure. Predetermination of the required level of understanding can be accomplished in a variety of ways. In the illustrated embodiment, the patient is asked several multi-choice questions at the conclusion of each module and must answer all questions correctly before proceeding. Thus, the required level of comprehension for each module is predetermined to be 100% accuracy on the questions presented. As will be appreciated, other measures of comprehension of the material presented can be used to determine whether the patient sufficiently understands the material to make an informed decision about whether to undergo the procedure.

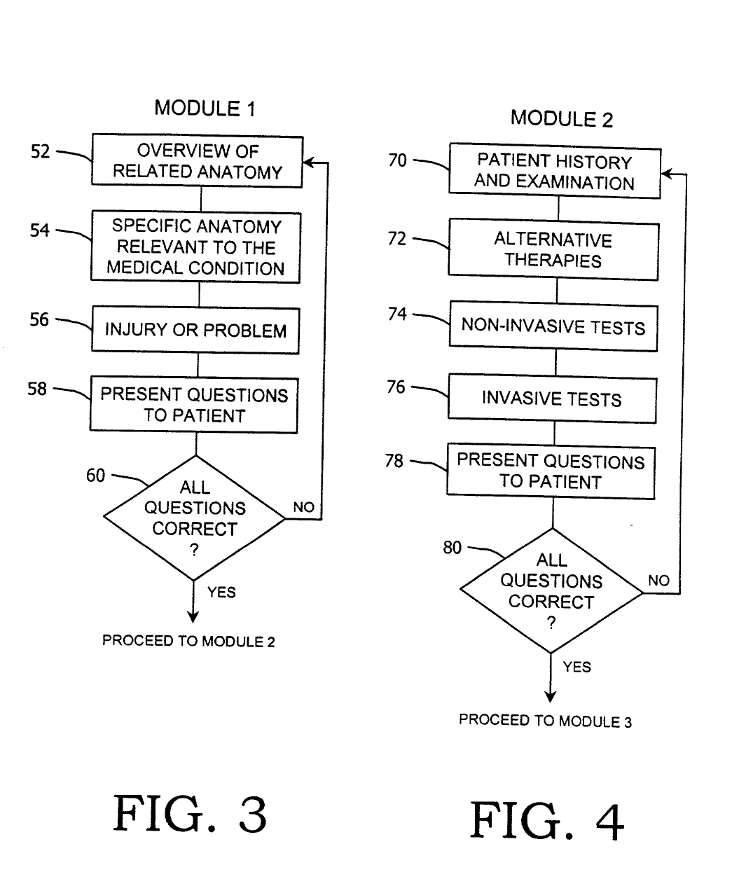

Referring now to FIG. 3, the process of lumbar disk surgery Module 1 will now be described. This module is used to provide the patient with an understanding of the injury and anatomy involved. The first step, shown at block 52, is an overview of related anatomy and is presented as one or more animated segments depicting the relevant anatomy on screen 24 with a simultaneous voiceover that describes the depicted anatomy using speaker 26. This may include a basic description and depiction of the spine, lumbar vertebrae, and disks. Then, the process moves to block 54 where the anatomy specific to the surgical procedure is described. This is again done using animation with a voice-over description of what is being shown. This portion of the module may include a description of the various parts of the vertebrae and disks and may include labeling of these parts. The animation can depict the anatomy from axial, sagittal, or other viewing directions in order to properly visualize the anatomical structures for the patient.

Once the anatomy of a healthy spine is described, the process moves to block 56 where the ruptured disk is described and the progression of the injury is shown using animation. Once this is completed, a number of questions are presented to the patient, as indicated at block 58. These questions can be in any form desired. For example, multiple choice questions can be displayed on monitor 24 or an image of the injury or related anatomy can be displayed and the patient asked to identify one or more parts of the depicted anatomy. Once the patient has answered the questions, a check is made at block 60 to determine if all questions were answered correctly. If not, the process returns to block 52 and the module repeats. If so, then Module 1 has been successfully completed and the process moves to Module 2 which provides a description of the diagnostic tests that may have been used to arrive at the diagnosis.

Turning to FIG. 4, Module 2 will now be described. As with Module 1, this module uses animation and voice-over to illustrate and describe the information presented. It begins at block 70 where the presentation explains how the physician has determined that the ruptured disk has occurred based upon the history taken and the physician's examination of the patient. Then, at block 72, alternative therapies are described, followed at blocks 74 and 76 by descriptions of the various non-invasive and invasive tests that may have been used to diagnose the lumbar disk injury. Animation can be used here to depict the procedures involved in the various tests. Once the presentation is complete, the patient is asked a number of questions related to the information presented in Module 2, as indicated at block 78. Computer 12 receives the answers and determines at block 80 whether all of the answers were correct. If not, the module repeats. If so, Module 2 has been successfully completed and the process moves to Module 3 which describes the procedure and risks.

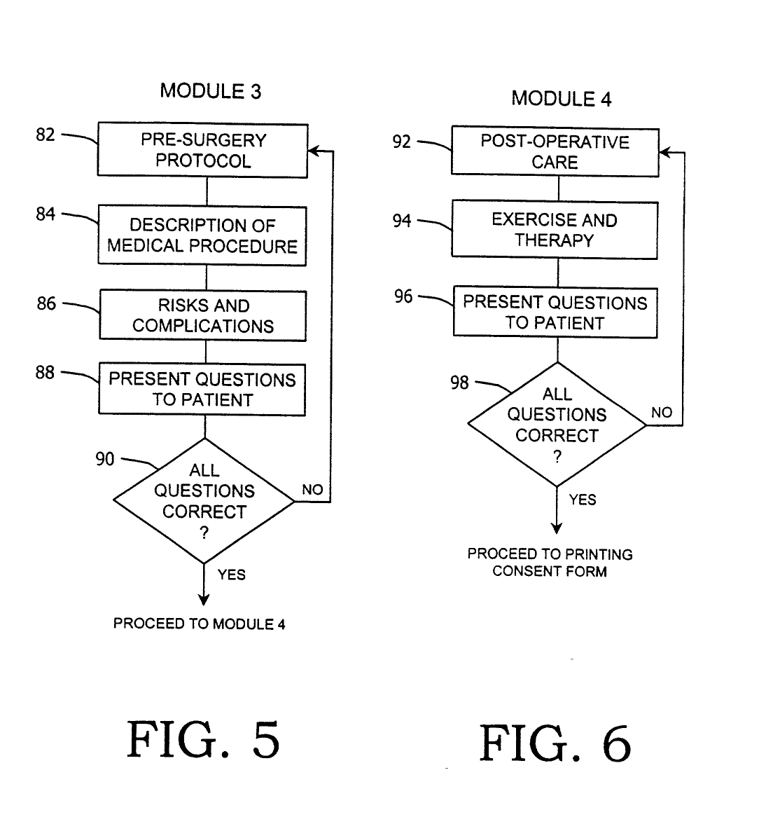

Referring now to FIG. 5, Module 3 begins at block 82 with a description of the pre-surgery process, including a discussion of the medical professionals with whom the patient will interact before surgery and a discussion of what to expect prior to being taken to the operating room for surgery. The lumbar disk surgery is then discussed at block 84 with animation being used to illustrate what the surgeon will be doing during the operation. Thereafter, the risks and possible complications will be discussed, as indicated at block 86. This may also include such information as the recurrence rate associated with the injury. Questions are then presented to the patient at block 88 and the answers are then checked at block 90 to determine whether all were correct. If not, the module repeats. If so, Module 3 has been successfully completed and the process moves to Module 4 where post-operative care and therapy are discussed.

Referring now to FIG. 6, Module 4 begins at block 92 with a description and illustration of what the patient can expect to experience after the surgery, including a discussion of post-operative precautions that the patient should follow and the medications that may be prescribed. Then, at block 94, there is provided instructions that the patient needs to follow for the long-term health of his or her injured disk. This may include certain exercises, which can be animated. A number of questions are then presented at block 96 and the answers checked at block 98. If any are incorrect, the module is repeated; otherwise, the process moves to the final step shown in FIG. 2; namely, printing of the consent form.

Program 14 can automatically print consent form 30 at the successful conclusion of the modules and can generate the form using some or all of the patient and physician data entered at the beginning of the program. The consent form can also include general or specific information concerning the medical procedure. The text of the consent form can be stored in memory, either on CD-ROM 16 or elsewhere and can be retrieved by program 14 to produce consent form 30. Optionally, the consent form can simply be displayed on monitor 24, with the patient indicating their consent by using mouse 22 to simply click on an “I consent” button displayed on the monitor. Once accepted in this manner, the acceptance can be automatically recorded by computer 12 and, if desired, can still be evidenced by a printed copy of the consent form which can be executed by the patient as documentary evidence of his or her consent. Once program 14 has completed printing consent form 30, it can either end execution or can return to one of the blocks 32-38 in preparation for the next patient.

In the illustrated embodiment described above, a module is repeated in its entirety whenever the patient answers any of the questions incorrectly. Alternatively, the program can be designed to repeat only that portion of the presentation that relates to the question(s) answered incorrectly or can be designed to provide additional information rather than simply repeat information. Moreover, program 14 can be designed to give the patient the option at any time of requesting further information regarding a particular aspect of the procedure.

As will be appreciated, the use of informed consent system 10 improves the process of obtaining informed consent since completion of the presentation only occurs after the patient has demonstrated that he or she sufficiently understands the information presented. This is advantageous for the patient because it helps insure that the patient understands the risks and makes a an informed decision. This is also advantageous for the physician who may be able to use the fact that the patient completed the presentation to later defend against a claim by the patient that he or she did not give informed consent. Similarly, since the computer produces the consent form only after the patient has demonstrated an understanding of the procedure and risks, the physician may be able to use this fact later as evidence that the patient consented only after being adequately informed about the procedure and attendant risks. Furthermore, use of informed consent system 10 allows the patient to learn about the proposed procedure without the expenditure of the physician's or office staff's time. Though the physician will also have input with the patient.

The animation used in the presentation can be generated using 3D Studio MAX, available from Kinetix of San Francisco, Calif. (www.ktx.com). Some or all of the models used by 3D Studio MAX to create the animation can be purchased from third party sources such as Viewpoint Data Labs of Orem, Utah. The presentations can be developed using Director, available from Macromedia, Inc. of San Francisco, Calif. (www.macromedia.com). The use of these software packages to create the animation and audiovisual presentations is known to those skilled in the art.

When developed for the Windows95, operating system, program 14 can set up on CD-ROM 16 to “autorun”; that is, to launch the program automatically after CD-ROM 16 is inserted into drive 18. Furthermore, as will be understood by those skilled in the art, upon automatically starting, the program can be designed to automatically determine whether the program has previously been installed on the computer. If not, the installation routine is run to set up the program on the computer. If the program has previously been installed, then the normal program operation shown in FIG. 2 begins automatically.

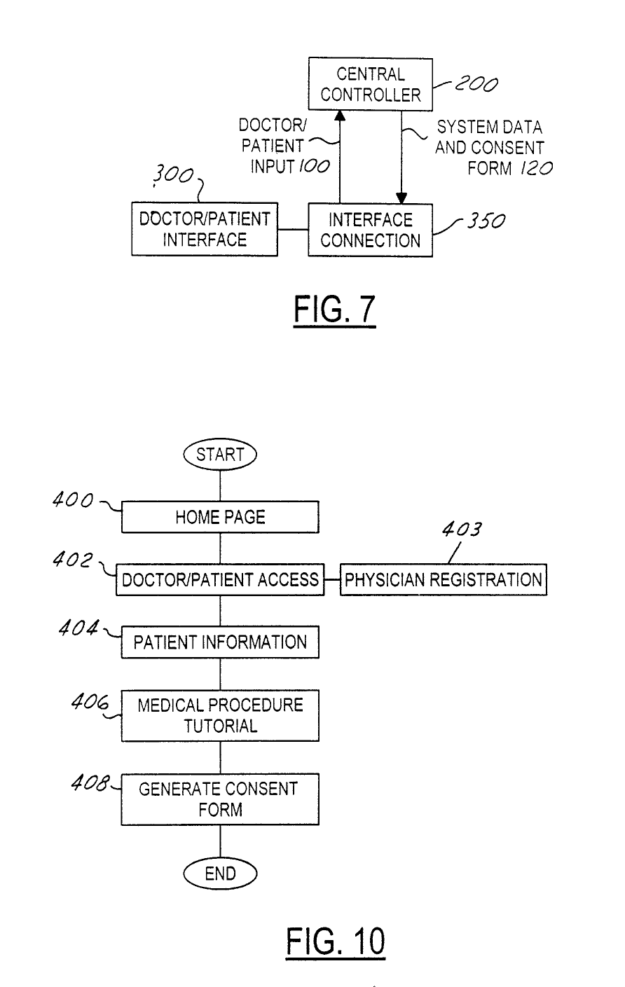

Referring now to FIG. 7, there is shown a block diagram of a network-based implementation of an informed consent certification procedure according to the present invention.

The system architecture is illustrated with reference to FIGS. 7 through 9. As shown in FIG. 7, the network-based system of the present invention comprises a central controller 200, and at least one doctor and/or patient interface 300. Each interface is connected via an Internet connection using a public switched phone network, such as those provided by a local or regional telephone operating company. Connection may also be provided by dedicated data lines, cellular, Personal Communication Systems (“PCS”), microwave, or satellite networks. Doctor/patient interface 300 is the input and output gateway for communications with central controller 200 via the network connection 350 such as a modem.

Using the above components, the present invention provides a method and apparatus to interactively provide a patient with information regarding a particular medical procedure and, in cooperation with their physician, provide informed consent to the procedure.

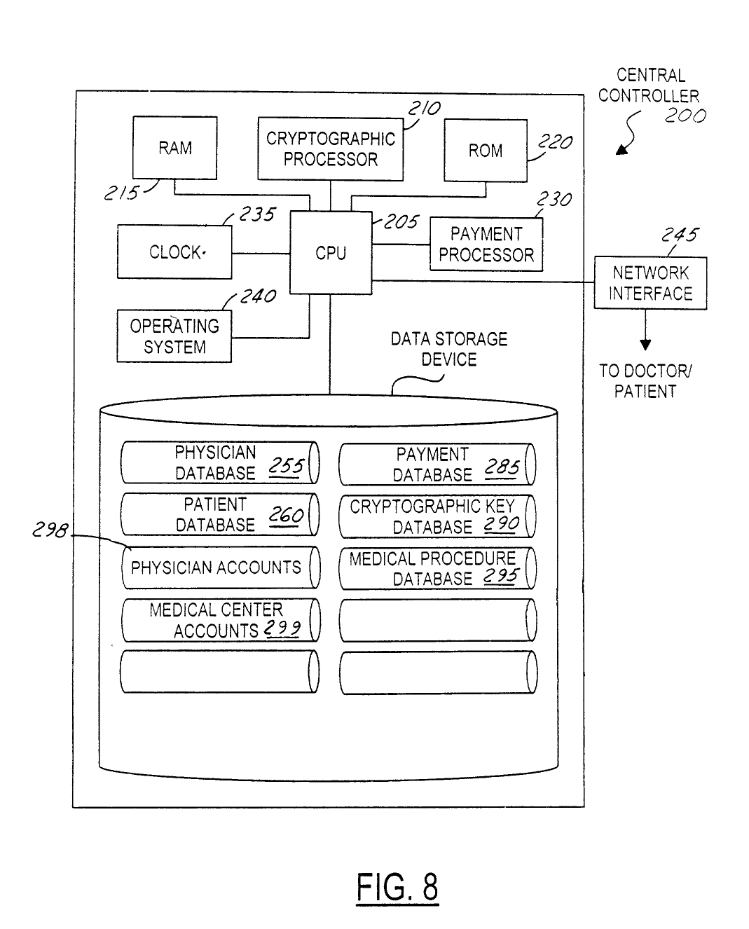

As shown in FIG. 8, central controller 200 includes central processor (CPU) 205, cryptographic processor 210, Random Access Memory (RAM) 215, Read Only Memory (ROM) 220, payment processor 230, clock 235, operating system 240, network interface 245, and data storage device 250.

A conventional personal computer or computer workstation with sufficient memory and processing capability may be used as central controller 200. In one embodiment, it operates as a web server, both receiving and transmitting data generated by physicians/patients. Central controller 200 is preferably capable of high volume transaction processing in processing communications and database searches. A Pentium-family microprocessor commonly manufactured by Intel, Inc. may be used for CPU 205. This processor employs a 32-bit architecture. Equivalent processors are also provided by Motorola or Sun Microsystems.

An MC68HC16 microcontroller, commonly manufactured by Motorola, Inc. may be used for cryptographic processor 210. Equivalent processors may also be used. This microcontroller utilizes a 16-bit multiply-and-accumulate instruction in the 16 MHz configuration and requires less than one second to perform a 512-bit RSA private key operation. Cryptographic processor 210 supports the authentication of communications from physicians and patients. Cryptographic processor 210 may also be configured as part of CPU 205. Other commercially available specialized cryptographic processors include VLSI Technology's 33 MHz 6868 or Semaphore Communications' 40 MHz Roadrunner 284.

Referring again to FIG. 8, payment processor 230 comprises one or more conventional microprocessors (such as the Intel Pentium family of processors), supporting the transfer and exchange of payments, charges, or debits, attendant to the method of the apparatus. Payment processor 230 may also be configured as part of CPU 205. Processing of credit card transactions by payment processor 230 may be supported with commercially available software. Such server software transmits credit card numbers electronically over the Internet to other servers where card verification and processing is handled.

Data storage device 250 may include hard disk magnetic or optical storage units, as well as CD-ROM drives or flash memory. Data storage device 250 contains databases used in the processing of transactions in the present invention, including physician database 255, patient database 260, payment database 285, cryptographic key database 290, and medical procedure database 295. In a preferred embodiment, database software such as that manufactured by Oracle Corporation is used to create and manage these databases. Data storage device 250 also stores information pertaining to physician account 298 and/or medical center accounts 299.

Physician database 255 maintains data on physicians registered to use the system with fields such as name, address, associated medical center, licenses/specialty, credit card number, phone number, ID number, social security number, electronic mail address, credit history, past system usage, public/private key information, etc. This information is obtained when the physician first registers with the system. Physician database 255 may also contain the tracking numbers associated with each patient consent generated by the system under the physician's registration number.

Patient database 260 maintains data on patients associated with a particular physician with fields such as name, address, phone number, date of birth, doctor, procedure to be performed, insurance carrier, and authorization code. As described in more detail below, the amount and type of patient information will vary depending upon the environment, i.e., their home or the doctor's office, in which they access the system.

Payment database 285 tracks all payments made by the physicians or medical centers with fields such as buyer name, buyer ID number, amount of payment, and associated tracking number. This database may also store credit card numbers of buyers.

Cryptographic key database 290 facilitates cryptographic functions, storing both symmetric and asymmetric keys. These keys are used by cryptographic processor 210 for encrypting and decrypting physician and patient data 100 as well as system data and the consent form information 120.

Medical procedure database 295 contains all of the data relating to the patient procedure under consideration. Each procedure can be stored in a single database 295 as shown or in separate databases. The data relating to each procedure includes modules discussing, for example, anatomy, pathology, symptom/procedure history, tests, the procedure itself, potential complications, and follow-up care as detailed above with regard to FIG. 2.

Physician account 298 tracks all information pertaining to the physician accounts with fields such as physician's name, bank and credit account numbers, and debit or credit transactions. This account may be a pointer to account data stored at the physician's bank or other financial institution.

In addition, or alternatively to physician accounts 298, medical center account 299 tracks all information pertaining to the medical center account with fields such as medical center name, bank and credit account numbers, associated physicians and debit or credit transactions.

Network interface 245 is the gateway to communicate with physicians and patients through the interface 300. Conventional internal or external modems may serve as network interface 245. Network interface 245 supports modems at a range of baud rates from 1200 upward, but may combine such inputs into a T1 or T3 line if more bandwidth is required. In a preferred embodiment, network interface 245 is connected with the Internet and/or any of the commercial on-line services such as America Online or Microsoft Network, allowing buyers and sellers access from a wide rang of on-line connections. Several commercial electronic mail servers also include the above functionality. Alternatively, network interface 245 may be configured as a web site.

While the above embodiment describes a single computer acting as central controller 200, those skilled in the art will realize that the functionality can be distributed over a plurality of computers. In one embodiment, central controller 200 is configured in a distributed architecture, wherein the databases and processors are housed in separate units or locations. Some controllers perform the primary processing functions and contain at a minimum RAM, ROM, and a general processor. Each of these controllers is attached to a WAN hub which serves as the primary communication link with the other controllers and interface devices. The WAN hub may have minimal processing capability itself, serving primarily as a communications router. Those skilled in the art will appreciate that an almost unlimited number of controllers may be supported. This arrangement yields a more dynamic and flexible system, less prone to catastrophic hardware failures affecting the entire system. This also provides flexibility in maintaining and upgrading the medical procedure presentations available on the system.

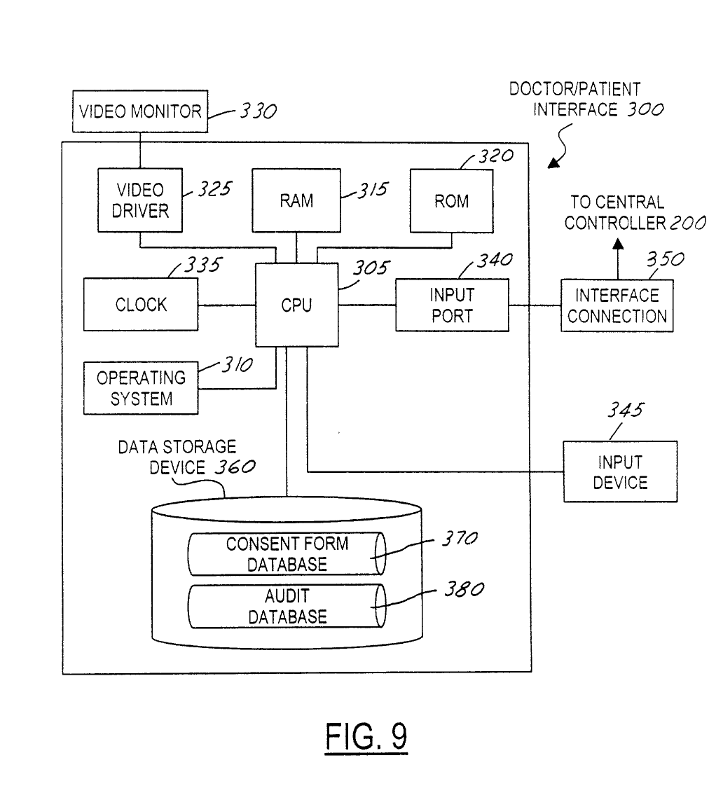

Referring now to FIG. 9, there is described physician and/or patient interface 300. In an exemplary embodiment, it comprises a conventional personal computer which includes a processing device such as central processor (CPU) 305; RAM 315; ROM 320; clock 335; video driver 325; video monitor 330; input port such as communication port 340; input device 345, such as a keyboard, mouse, or conventional voice recognition software package; a network interface such as a modem 350; and data storage device 360. The device interfaces with central controller 200. Cryptographic processor 310 may be added for improved authentication and security as is known in the art. A Pentium-family microprocessor may be used for CPU 305. Clock 335 is a standard chip-based clock which can serve to time stamp data transmissions produced with the interface 300.

Data storage device 360 is a conventional magnetic-based hard disk storage unit. Consent form database 370 may be used for archiving patient consent forms produced by the system, while audit database 380 may be used for recording payment records and communications with central controller 200.

There are many commercial software applications that can enable the communications required by the interface 300, the primary functionality being message creation and transmission. When central controller 200 is configured as a web server, conventional communications software such as the Netscape navigator web browser from Netscape Corporation or Internet Explorer web browser from Microsoft Corporation may also be used. The physician and patient may use the browser to transmit data. Preferably, no proprietary software is required.

In one embodiment of the present invention, communications between physicians/patients and the system take place via electronic networks, with central controller 200 acting as a web server. The physician logs onto central controller 220, receives an authorization code allowing a patient to interact with the system, the patient is informed of the procedure by a procedure presentation as described above, an informed consent document is created, and the patient executes the informed consent document in consultation with their physician. Additional steps may include payment by the physician or medical center for use of the system.

Authentication of the physician and patient involves checking the associated ID or name and comparing it with those stored in physician database 255 and/or patient database 260. Although this procedure works well in a low security environment, it can be significantly improved through the use of cryptographic protocols. These protocols not only enhance the ability to authenticate the sender of a message, but also serve to verify the integrity of the message itself, proving that is has not been altered during transmission. Encryption can also prevent eavesdroppers from learning the contents of the message. The practice of using cryptographic protocols to ensure the authenticity of senders as well as the integrity of messages is well-known in the art and need not be described here in detail. Depending upon the encryption desired, cryptographic processors 210, 310 may be required. Preferably, however, Encryption Software such as is known in the art is used to provide sufficient security and integrity assurances.

With reference to FIG. 10, the process by which a physician and patient interact with the system will now be described. In this embodiment, communications between physicians or patients and the system take place via electronic networks, with the central controller 200 acting as a web server. At step 400, the physician or patient is greeted by a home page (www.YourSurgery.com). The home page provides general information about the system provider as well as links to the surgical procedures within the system.

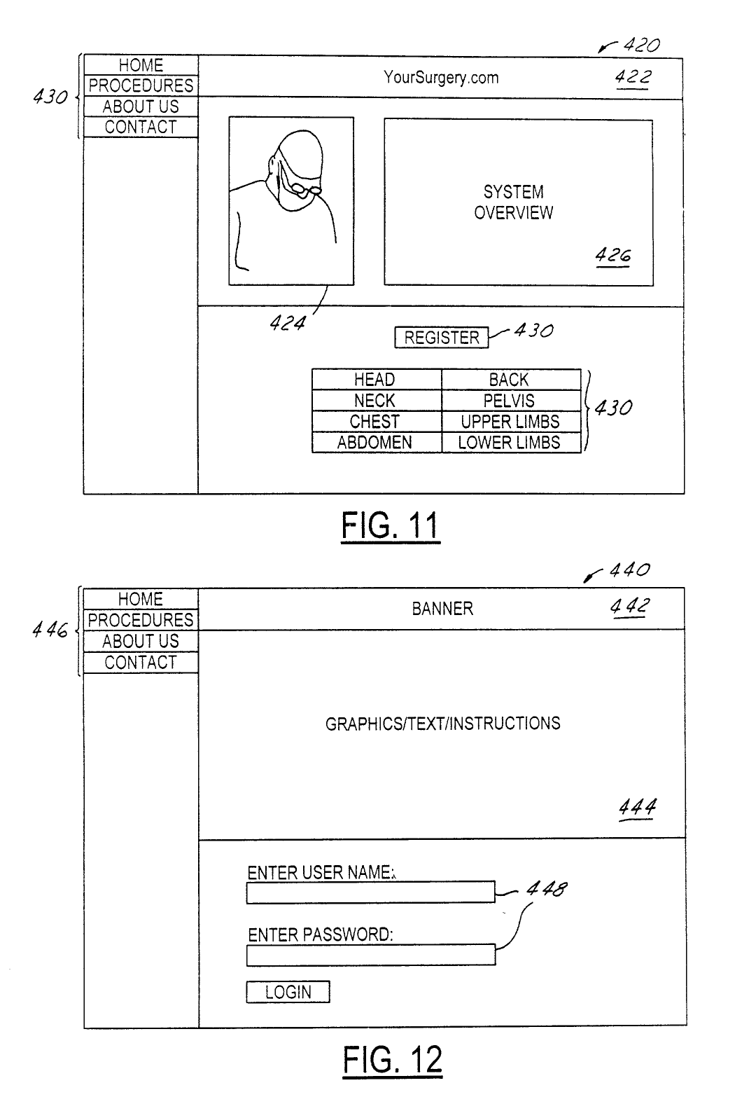

A representative home page for network-based system is shown in FIG. 11. Referring to FIG. 11, the home page 420 preferably includes a banner 422 identifying the system name and/or provider, graphics 424 and text 426 to provide an informative and visually appealing presentation. The home page 420 also includes links 430 to other portions of the system as will be described in further detail below.

Referring again to FIG. 10, from the home page links 430, the doctor and/or patient can access the system in step 402. An example of a network-based implementation of the doctor/patient access site is shown in FIG. 12. The doctor/patient access site 440 includes a banner region 442, an instruction region 444 which contains text and/or graphics, additional links 446 to other parts of the system, and data input fields 448 for inputting information and communicating with the system. Preferably, the doctor and/or patient enters a user name and password to initiate the communications with the system. By using user names and passwords, the system provides flexibility to doctors and patients by allowing them to access the system from any networked device. Thus, when a patient is in the doctor's office, the doctor can enter a user name and password, access the system, and review the information together with the patient until the patient has a satisfactory understanding of the procedure to provide informed consent. Alternatively, once the physician has entered a user name and password and the appropriate patient information has been input into the system, the patient may be left unattended to interact with the system at a pace which is comfortable for the patient to achieve a desired understanding of the procedure such that informed consent may be provided. In this regard, it is also contemplated that, should the patient desire additional time to review the procedure data either alone or in the presence of a family member or a friend, for example, the physician need only supply the appropriate URL to the patient. Alternatively, the physician could supply a patient user name and password to the patient. The patient could then go home and, if the patient has access to the Internet, review the procedure information again until they have achieved a satisfactory level of understanding of the procedure. The patent then returns to the physician's office for a follow-up consultation and discussions before providing their informed consent.

Referring again to FIG. 10, if it is the physician's first time interacting with the system, the physician must register to gain access. Physician registration is accomplished in step 403. The physician registration process gathers such information as the physician's name, address, affiliated medical center, and professional license (MD or DO). If the system is to be a fee-based service for physicians, the physician would also supply, for example, a credit card account number or their affiliated medical center's account number to the system. The physician data input is also used to personalize the informed consent form generated by the system at the end of the consultation. In other words, some or all of this information is included on the consent form generated by the system.

In step 404, patient information is communicated to the system. The patient information includes such things as the patient's name, their date of birth, and the surgical procedure they are contemplating. The relevant surgical procedure may be entered by the physician or patient, or chosen from a list of procedures available for viewing on the system. Like the physician information, the patient information is entered into the system by the input device 345 (FIG. 9).

In step 406, the medical procedure tutorial is conducted. This is carried out as described above with reference to FIGS. 2-6. Thus, the medical procedure is discussed as a series of modules relating to different aspects of the procedure. The material may be presented with a voice-over and include multilingual formats.

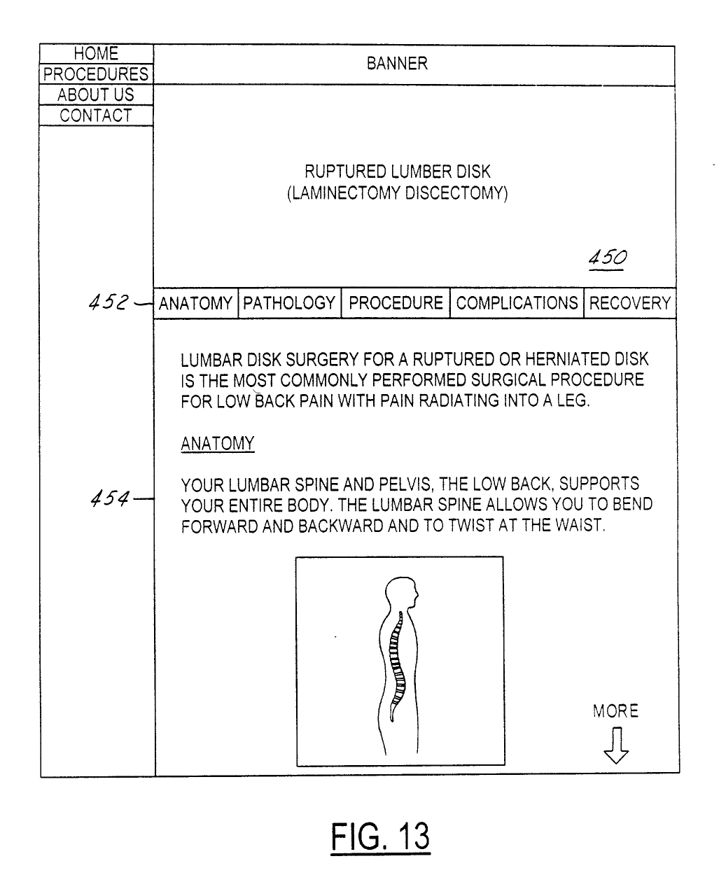

An example of a medical procedure tutorial for a network-based implementation of the present system is shown in FIG. 13. In this example, a medical procedure tutorial for a ruptured lumbar disc (laminectomy discectomy) is shown. The medical procedure under discussion is identified at 450 as well as the corresponding modules 452 for the medical procedure. In FIG. 13, module links 452 are provided for anatomy, pathology, the procedure, potential complications, and the recovery experience. The presentation for the module selected is displayed in region 454. In this example, the beginning of the anatomy discussion for a ruptured lumbar disc surgery is displayed. The information relating to each module can be presented passively or interactively to the user. In the interactive embodiment, the user is required to demonstrate a level of understanding with respect to each module by correctly answering one or more questions related to the information presented in that module. In the passive embodiment, there is no feedback from the patient requiring demonstration of their understanding. The information is merely presented, and the patient is encouraged to discuss questions they may have with their physician.

Referring again to FIG. 10, once the patient has reviewed all of the modules for the surgical procedure under consideration and/or successfully demonstrated a level of understanding of the procedure, the system generates a consent form in step 408 for review with the physician and signature by the patient. The consent form generated may include some or all of the patient and physician data gathered in steps 402 and 404, as well as general or specific information concerning the medical procedure as presented in the medical procedure tutorial at step 406. The text of the consent form can be stored both on the physician's computer as well as the central controller of the system such as in the patient database 260 of FIG. 8. The consent form itself can simply be displayed on the monitor with the patient indicating their consent by using a mouse or other input device to simply click on in “I consent” button displayed on the monitor. Once accepted in this manner, the acceptance can automatically be recorded by the physician's computer and, if desired, the central controller. Preferably, the consent form is evidenced by a printed copy of the consent form which can be executed by the patient as documentary evidence of his or her consent. In either case, however, the system does not certify that the requisite legal requirements of informed consent have been met. This is the duty of the physician. The system, through the use of teaching modules or information presentation, merely aids the physician in achieving informed consent of the patient prior to conducting a medical procedure. Once the system has completed printing the consent form, it can either end execution or return to the home page or doctor/patient access page in preparation for the next patient consultation.

It will, thus, be apparent that there has been provided, in accordance with the present invention, an automated informed consent system which achieves the aims and advantages specified herein. It will, of course, be understood that the foregoing description is of preferred exemplary embodiments of the invention and that the invention is not limited to the specific embodiments shown. For example, although the use of the invention has been described as it might be used for obtaining consent for lumbar disk surgery, it will, of course, be understood that the invention can be used in connection with any type of surgery or other medical procedure. Various other changes and modifications will become apparent to those skilled in the art and all such variations and modifications are intended to come within the scope of the appended claims.

What is claimed is:

1. A system for use by a patient to provide informed consent to a medical procedure, comprising:
a patient interface connected to a network, the patient interface having at least one input device for use by the patient to provide input to the interface and a screen for displaying information to the patient; and
a server connected to the network in operative communication with the patient interface, the server including a program stored in memory and accessible by the patient interface;
the interface being operable under control of the program to present information concerning a medical procedure to the patient via the screen, to request input from the patient via the input device, and to determine from the input whether the patient has reviewed all of the information presented; and
the interface further being operable under control of the program to generate a consent form for the medical procedure for review by a physician and execution by the patient.

2. The system of claim 1 wherein the interface is further operable under control of the program to determine from the input whether the patient has achieved a predetermined level of understanding of the information presented.

3. The system of claim 2 wherein the interface is further operable under control of the program to provide the patient with repeated information concerning the medical procedure until the patient demonstrates via the input device that the patient has achieved the predetermined level of understanding.

4. The system of claim 2 wherein the interface is further operable under control of the program to provide the patient with additional information concerning the medical procedure until the patient demonstrates via the input device that the patient has achieved the predetermined level of understanding.

5. The system of claim 1 wherein the interface is a computer and the network is the internet.

6. The system of claim 1 wherein the interface is further operable under control of the program to present the information as a plurality of modules, with each module including a presentation of information followed by testing of the patient on the information presented during that module using the input device.

7. The system of claim 6 wherein the modules include a module directed to a description of the medical condition to be treated by the medical procedure and at least one module directed to the medical procedure and potential complications resulting from the procedure.

8. The system of claim 7 wherein the modules further include a module directed to diagnostic tests for the medical condition and a module directed toward post-operative care.

9. The system of claim 6 wherein the interface is operable under the control of the program to determine whether the patient has achieved the predetermined level of understanding of the information presented by determining, for each module, whether the patient has achieved a predetermined level of comprehension of the information presented during that module.

10. The system of claim 1 wherein the consent form is stored in memory on the server.

11. The system of claim 1 wherein the consent form is stored in memory on the patient interface.

12. The system of claim 1 wherein the server includes partitioned memory comprising a physician database for storing information regarding all physicians registered to access the system, and a medical procedure database for storing information regarding a plurality of medical procedures.

13. The system of claim 12 wherein the partitioned memory further includes a payment database for storing fee-based transactions with the system.

14. The system of claim 12 wherein the partitioned memory further includes a patient database for storing information regarding all patients registered to access the system.

15. The system of claim 1 wherein the server further includes an encryption controller for securing data transmitted between the patient interface and server.

16. An apparatus for use by a patient to provide informed consent to a medical procedure, comprising:
a storage device;
a processor connected to the storage device;
at least one input device for use by the patient to provide input to the apparatus;
a screen for displaying information to the patient; and
a network interface connected to the processor and a network server including a program stored in memory and accessible by the processor;
the processor operative with the program to provide physician and patient information to the server;
select, via the input device, a medical procedure from a predetermined group of medical procedures;
receive information concerning the selected medical procedure via the screen;
request input from the patient via the input device to determine from the input whether the patient has reviewed all of the information presented; and
generate a consent form for the selected medical procedure for review by a physician and execution by the patient.

17. The apparatus of claim 16 in which the processor is further operative with the program to receive a physician identification and password.

18. The apparatus of claim 16 in which the processor is further operative with the program to determine from the input whether the patient has achieved a predetermined level of understanding of the information presented.

19. The apparatus of claim 18 in which the processor is further operative with the program to provide the patient with repeated information concerning the medical procedure until the patient demonstrates via the input device that the patient has achieved the predetermined level of understanding.

20. The apparatus of claim 18 in which the processor is further operative with the program to provide the patient with additional information concerning the medical procedure until the patient demonstrates via the input device that the patient has achieved the predetermined level of understanding.

21. The apparatus of claim 16 wherein the network interface is connected to the network server via the Internet.

22. The apparatus of claim 16 in which the processor is further operative with the program to present the information as a plurality of modules, with each module including a presentation of information followed by testing of the patient on the information presented during that module using the input device.

23. The apparatus of claim 22 wherein the modules include a module directed to a description of the medical condition to be treated by the selected medical procedure and at least one module directed to the selected medical procedure and potential complications resulting from the procedure.

24. The apparatus of claim 23 wherein the modules further include a module directed to diagnostic tests for the selected medical condition and a module directed toward post-operative care.

25. The apparatus of claim 22 in which the processor is further operative under the control of the program to determine whether the patient has achieved the predetermined level of understanding of the information presented by determining, for each module, whether the patient has achieved a predetermined level of comprehension of the information presented during that module.

26. An apparatus for facilitating a patient to provide informed consent to a medical procedure, comprising:
a storage device;
a processor connected to the storage device;
a network interface connected to the processor;
the storage device storing a program for controlling the processor; and
the processor operative with the program to receive physician information, patient information, and a selected medical procedure from a networked computer via the network interface;
transmit to the networked computer information concerning the selected medical procedure via the network interface;
request and receive input from the patient to determine from the input whether the patient has reviewed all of the information presented; and
generate a consent form for the selected medical procedure for review by a physician and execution by the patient.

27. The apparatus of claim 26 in which the processor is further operative with the program to receive a physician identification and password.

28. The apparatus of claim 26 in which the processor is further operative with the program to determine from the input whether the patient has achieved a predetermined level of understanding of the information presented.

29. The apparatus of claim 28 in which the processor is further operative with the program to provide the patient with repeated information concerning the medical procedure until the patient demonstrates that the patient has achieved the predetermined level of understanding.

30. The apparatus of claim 28 in which the processor is further operative with the program to provide the patient with additional information concerning the medical procedure until the patient demonstrates that the patient has achieved the predetermined level of understanding.

31. The apparatus of claim 26 wherein the network interface is connected to the network computer via the Internet.

32. The apparatus of claim 26 in which the processor is further operative with the program to present the information as a plurality of modules, with each module including a presentation of information followed by testing of the patient on the information presented during that module.

33. The apparatus of claim 32 wherein the modules include a module directed to a description of the medical condition to be treated by the selected medical procedure and at least one module directed to the selected medical procedure and potential complications resulting from the procedure.

34. The apparatus of claim 33 wherein the modules further include a module directed to diagnostic tests for the selected medical condition and a module directed toward post-operative care.

35. The apparatus of claim 32 in which the processor is further operative under the control of the program to determine whether the patient has achieved the predetermined level of understanding of the information presented by determining, for each module, whether the patient has achieved a predetermined level of comprehension of the information presented during that module.

36. The apparatus of claim 26 wherein the storage device includes partitioned memory comprising a physician database for storing information regarding all physicians registered to access the system, and a medical procedure database for storing information regarding a plurality of medical procedures.

37. The apparatus of claim 27 wherein the partitioned memory further includes a payment database for storing fee-based transactions with the system.

38. The apparatus of claim 27 wherein the partitioned memory further includes a patient database for storing information regarding all patients registered to access the system.

39. The apparatus of claim 26 further including an encryption controller for securing data transmitted between the networked computer and processor.
